(19) United States
(12) Patent Application Publication
(10) Pub. No.: US 2025/0028437 A1
(43) Pub. Date: Jan. 23, 2025

(54) DYNAMIC WEB COMPONENT WITH CONFIGURABLE CONTENT

(71) Applicant: ServiceNow, Inc., Santa Clara, CA (US)

(72) Inventors: Kiran Mushnuri, Hyderabad (IN); Raghu Prasad Mulukoju, Hyderabad (IN)

(21) Appl. No.: 18/222,844

(22) Filed: Jul. 17, 2023

(51) Int. Cl. G06F 3/0486; G06F 16/955; G06F 40/205

(52) U.S. Cl. CPC G06F 3/0486; G06F 16/9566; G06F 40/205

(57) ABSTRACT

In various embodiments, a process for providing a dynamic Web component with configurable content includes receiving an instruction to move a component from a first portion of a user interface to a second portion of the user interface for application on the second portion of the user interface, wherein the second portion is configured to receive an input from a user. The process includes programmatically analyzing content of the second portion to select a machine learning model, and determining, for the user, the input to the second portion using the selected machine learning model.

### BACKGROUND OF THE INVENTION

In various circumstances, a software application is designed to perform one or more actions for a user. For example, an application facilitates a process to approve a recipient list for a particular workflow. The application may present a list of recipients for the user to review, and upon review of each recipient, the user indicates approval or rejection by clicking a button on a page of the application. The user action (e.g., approve or reject a recipient) may be time-consuming or tedious for the user to perform. A technique for facilitating the user action is typically tailored to a specific application. Therefore, development time and resources are needed to modify the technique for applicability to other applications.

### BRIEF DESCRIPTION OF THE DRAWINGS

Various embodiments of the invention are disclosed in the following detailed description and the accompanying drawings.

FIG. 1 is a flow diagram illustrating an embodiment of a process for providing a dynamic Web component with configurable content.

FIG. 2 is a block diagram illustrating an embodiment of a system for providing a dynamic Web component with configurable content.

FIG. 3 is a diagram illustrating an example of a graphical user interface for providing a dynamic Web component with configurable content.

FIG. 4 is a functional diagram illustrating a programmed computer system for providing a dynamic Web component with configurable content in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term “processor” refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, an “application” refers to any functionality or service that can be provided by a computer. For example, an application may include a computer executable program running on a client device such as a computer or smartphone. As used herein, a “dynamic Web component” (DWC) refers to a reusable component with functions that allow for encapsulation and interoperability of individual HyperText Markup Language (HTML) elements. For example, a Web component includes a set of Web platform application programming interfaces (APIs) that allow a designer to create custom, reusable, encapsulated HTML tags that can interact or be used in Web pages and/or applications. Web components are typically compatible with many browsers and can be used with any JavaScript library or framework that works with HTML. A Web component is dynamic when it can be adapted to different data. For example, the DWC is automatically customizable to display customized text or execute specific functions depending on the data in an associated Web page in which it is to be used.

A DWC can be embedded (e.g., plug-and-play or drag-and-drop) into any application. The embedded DWC determines an action to take by using a machine learning (ML) model to determine an appropriate action to perform in the circumstances. The action may replace or automate an action of a user. For example, in a recipient list approval process, a user can drag and drop the DWC onto a queue approval page. The DWC determines the type of page and correspondingly the type of action to be taken by reading the metadata and other information on the page. The DWC determines the action to take by automatically selecting a trained ML model that ingests the information of the page and decides what action to perform. Thus, the user does not need to approve or reject recipients and instead they are automatically approved based on the decision made by the ML model. Regardless of the type of page, the DWC can determine the appropriate action to take.

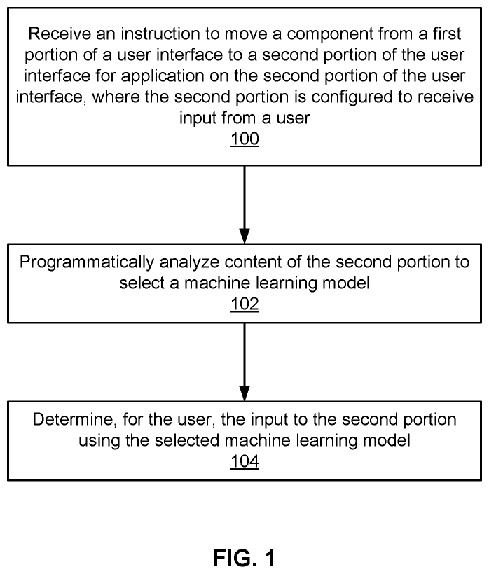

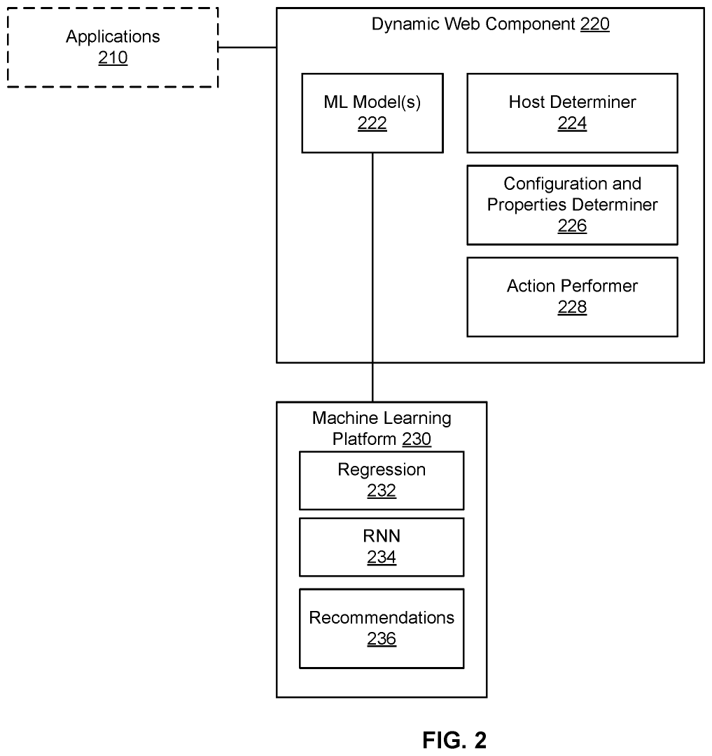

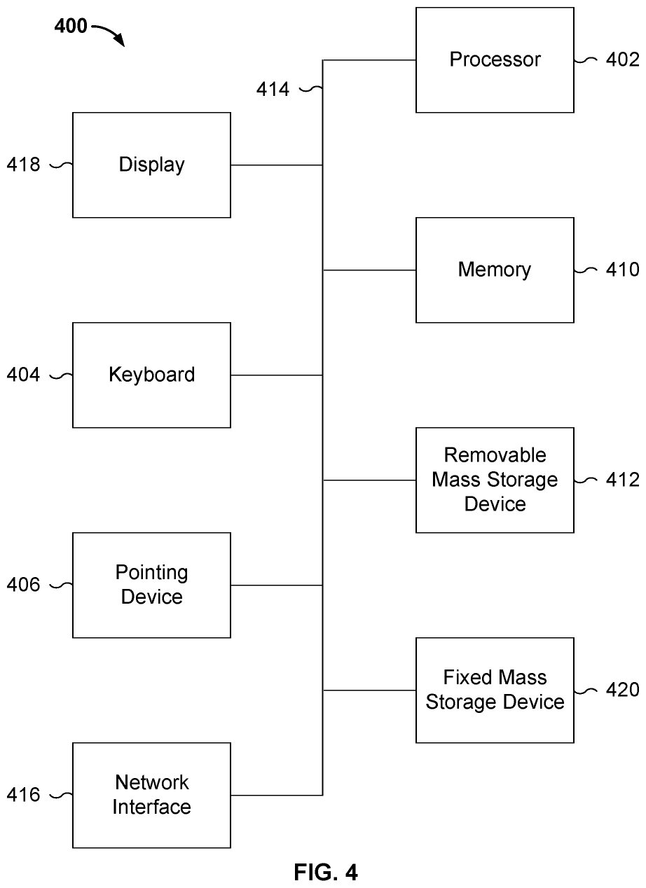

FIG. 1 is a flow diagram illustrating an embodiment of a process for providing a dynamic Web component with configurable content. This process may be implemented on or by the dynamic web component 220 of FIG. 2 or processor 402 of FIG. 4.

In the example shown, the process begins by receiving an instruction to move a component from a first portion of a user interface to a second portion of the user interface for application on the second portion of the user interface, where the second portion is configured to receive an input from a user (100). In various embodiments, the instruction to move a component from a first portion of a user interface to a second portion of the user interface includes dragging the component from the first portion and dropping the component to the second portion to cause the component to be applied to the second portion of the user interface. For example, the component (a dynamic Web component or “DWC”) is “dragged” from the first portion and “dropped” to the second portion. The drag and drop causes the DWC to be “applied” or “embedded” onto a page of an application, which triggers at least a portion of the process of FIG. 1 to be performed.

The process programmatically analyzes content of the second portion to select a machine learning model (102). An appropriate ML model to use for a particular context may be determined by analyzing the content or environment in which the component is embedded.

In various embodiments, programmatically analyzing content of the second portion to select a ML model includes determining at least one host capability of an application associated with the user interface. Referring to the example in which a DWC is dragged and dropped onto a page of an application, host capabilities of the page/application may be determined. For example, a host capability of the application associated with the user interface may be determined based on a host name, a contextual uniform resource locator (URL), or the like. The URL can be parsed to extract at least one keyword, and a function of a page associated with the application is determined based on a lookup of the at least one keyword in a lookup table.

In various embodiments, programmatically analyzing content of the second portion to select a ML model includes determining a configuration and/or a property of an application associated with the user interface. By way of non-limiting example, the configuration or the property of the application associated with the user interface includes at least one of: metadata of a page associated with the application, a widget, or a Document Object Model (DOM) element. A page type associated with the application may be determined based on the configuration or the property of the application associated with the user interface.

In various embodiments, programmatically analyzing content of the second portion to select a ML model includes determining a page of an application associated with the second portion and selecting the ML model based on the determined page. Information associated with the determined page may be used to train the ML model

The process determines, for the user, the input to the second portion using the selected machine learning model (104). In various embodiments, determining the input to the second portion using the selected ML model includes determining an action to perform with respect to the second portion on behalf of the user. In various embodiments, determining the input to the second portion using the selected ML model includes using the selected ML model to determine permitted actions to take with respect to the second portion.

In various embodiments, the process takes at least one action from among the determined permitted actions to take with respect to the second portion. Example actions include but are not limited to populating data in a form and validating data. For example, taking an action includes populating data in the second portion using a key-value pair for at least one link in the second portion. As another example, taking an action includes validating data including by determining applicable rule(s) for the second portion, and validating data in the second portion based on at least one rule.

The next figure shows an example of a system for providing a DWC.

FIG. 2 is a block diagram illustrating an embodiment of a system for providing a dynamic Web component with configurable content. The system includes a machine learning (ML) platform 230, a dynamic Web component (DWC) 220, and optionally one or more applications 220.

The DWC 120 is communicatively coupled to ML platform 230 and one or more applications 210. The DWC includes one or more ML models 222 that can be trained using the ML platform 230. Some example models are shown with respect to the ML platform 230, which includes a regression model 232, recurrent neural network (RNN) 234, and recommendations model 236. Each of the models may be trained to perform specific tasks. These examples are merely exemplary and not intended to be limiting as other models may be included. The DWC 220 has various ML models 222 trained to perform various functions/actions depending on the environment in which the DWC becomes embedded.

The DWC includes a host determiner 224 configured to determine the host capabilities of an application/environment in which the DWC may become embedded. For example, the host determiner is configured to perform 102 of FIG. 1.

The DWC includes a configuration and properties determiner 226 configured to determine the configurations and/or properties of an application/environment in which the DWC may become embedded. For example, the configuration and properties determiner is configured to perform 102 of FIG. 1.

The DWC includes an action performer 228 configured to perform an action appropriate for the application/environment in which the DWC may become embedded. The action may be determined based on the analysis of the content of the application/environment.

An example of an approval of a recipient list for a particular workflow will now be described to illustrate the process of FIG. 1. This example is not intended to be limiting as the disclosed DWC can be configured for any application. In this example, a workflow may involve approving a document to be distributed to members of a recipient list.

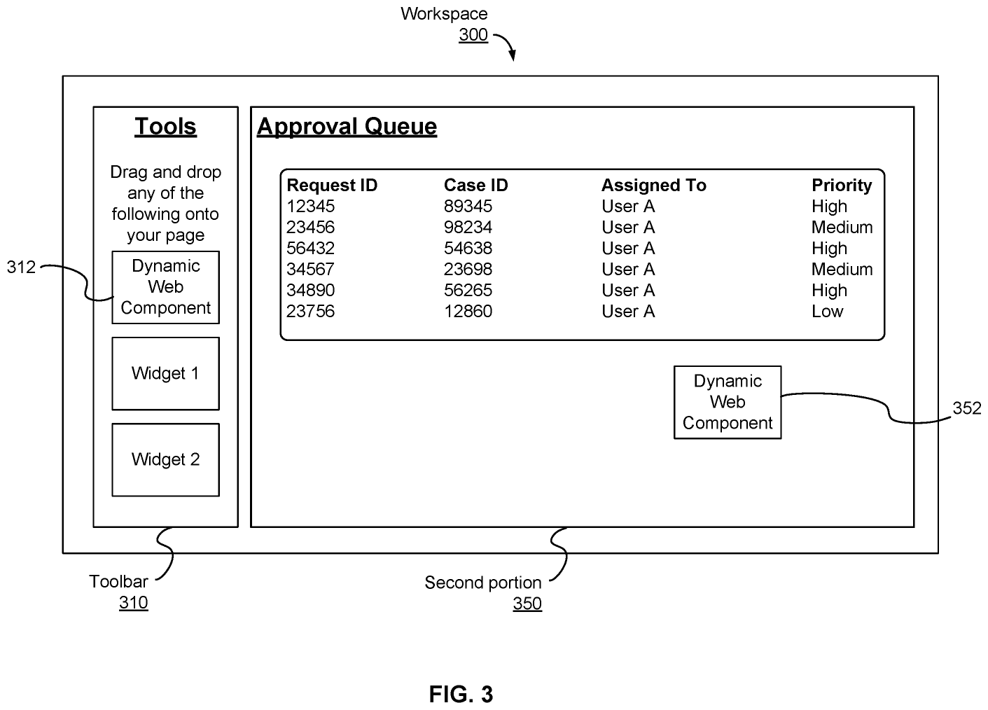

FIG. 3 is a diagram illustrating an example of a graphical user interface for providing a dynamic Web component with configurable content. This graphical user interface (GUI) shows an application/platform in which a user can use various tools provided in toolbar 310 to manipulate, automate, or otherwise interact with the second portion 350. For example, a user can drag a dynamic Web component (DWC) 312 and drop it into the second portion 350, as represented by DWC 352. Doing so will cause the DWC to become embedded in the second portion, triggering the process of FIG. 1 to be performed.

In this example, the workflow involves reviewing contents of a document, and obtaining approvals from various departments in the company. Documents are received by a first department of the company and distributed to other departments for review and approval. The first department sends a request to the relevant department. Each request has an associated document. For example, content of the document relevant to the department may be extracted and included in the request. A request may have several levels or stages. For example, at the first level, a recipient approves terms of the request (extracted from the document) such as being within budget for a particular category and dates fall within a particular quarter of the fiscal year. Suppose that the dates are acceptable, but the request is beyond the range of what is typically allowed in the budget. The request would advance to the second level, where another recipient with more discretionary authority can review this aspect of the request. Suppose that the request is approved at the second level. Then, at the third level, the request advances to another stage where an appropriate recipient reviews the relevant contents of the document to ensure that it matches the terms that were approved by an earlier user (e.g., the recipient with more discretionary authority). The request is finally fully approved when all levels have approved.

Here, a list of requests are shown in the approval queue, each identified by a unique request ID. Each request has an accompanying case (e.g., document), an associated user to whom the request is assigned, and a priority. The request review process can be expedited for User A using the disclosed techniques. Instead of manually reviewing each request, User A may instead use the DWC 352 to automatically approve requests.

A DWC 352 is activated, e.g., this corresponds to 100 of FIG. 1. For example, a DWC gets embedded into a page of an application when an end user (User A for example) drags and drops the DWC onto a page of an application.

Here, the end user uses a software application to review and approve requests/contracts. The software application has a number of pages including: a login page, a queue approval page, and one or more request pages. Typically, the end user would enter credentials via the login page. Upon a match of credentials, the user can navigate to the queue approval page where they can see a list of requests, cases, assignments, and priority as shown in FIG. 3. The user may select each Request ID to review the details of the request and approve, reject, or escalate the request. A user may drag and drop the DWC onto the queue approval page by dragging the DWC from the toolbar on the left side onto the main page on the right side.

When the DWC is dragged onto the page, it is able to determine characteristics of the page and application in which it has been embedded, e.g., this corresponds to 102 of FIG. 1. The host capabilities of the application are determined. For example, the host name and contextual URL may indicate the capabilities of the host. An example host name is “request approval” and an example URL of the page is: www.example.com/request_approval/page1.html The process parses the URL to extract the host name “request approval,” and page “page1”. The process can look up key words such as “request” to infer that the application is for request/document review. The page number indicates that the page in which the DWC is embedded is for reviewing a queue of cases because the process infers that page0 is a login page, page1 is a queue list page, and page2 is a review and approval page.

In various embodiments, the DWC has a mapping of a page type and a capability. If the UI of the page is a workflow, then the mapping will show that the page capability or expected input/action from the user includes approvals. The DWC passes this workflow information to an ML model and the ML model predicts whether requests can be approved. Here, the DWC passes the information such as the page details (which UI, requests, processor, etc.) to ML Model. In various embodiments, the ML model is trained with the historical data such as userId, request type, how many approvals are needed, approved/rejected, applicationId, processId, approvedOn date. The model may improve in performance over time as more and/or better training data is obtained. In various embodiments, ML model training techniques include neural network Regression and time series analysis.

In various embodiments, configurations and properties of the application are determined, e.g., this corresponds to 102 of FIG. 1. For example, the configurations and properties of a certain page (of the application) onto which the DWC is dropped are determined. Examples of configurations and properties include metadata of the page, widgets, DOM elements, and the like. For example, in the request approval page of FIG. 3, the request ID, table and list of items indicates that the items are requests to be approved in an approval page.

A ML model is used to determine an action to perform based at least on the determined host capabilities, configurations, and properties, e.g., this corresponds to 104 of FIG. 1. For example, for the approval process, the action is to approve or reject a request. The action can be performed automatically so that requests get auto-approved instead of needing the user to review each request individually.

In the example of the contract approval process, an action to perform for each request ID can be automatically determined by reading each request ID and making a call to each link with the request ID. In various embodiments, this is equivalent to a user clicking each link to review each request but instead the process automatically performs this without requiring the user to individually review the requests.

For each request ID/link, the DWC fetches the metadata of the page including the widgets and data. The DWC fetches metadata of the page such as a table (columns and content in the table) and whether there are links in the table or any POST buttons (such as submit). If there is a submit button then, the DWC determines that the page expects a validation action. If the page contains a link in the table, then that means the action expects routing to the page. Thus, the DWC understands the intent of the page based on the widgets. In various embodiments, there is a mapping of page widgets and actions in the DWC. The process connects to a respective system of records (SOR). The DWC determines which SORs it needs to connect to and validate based on the page (e.g., the host capabilities and/or configurations/properties. In various embodiments, the DWC has a mapping of page to SOR (or vice versa). The DWC uses the mapping to connect to the SOR(s) when the page loads.

Depending on the context of the widgets/page, the DWC tries to fetch the data from the SOR. For example, based on the request ID, the process also checks whether the request is part of a multiple approval process. For example, the request ID is used for validations as follows. If a table has various columns and one column is a link, then the column is expected to already be mapped with a unique ID, e.g., Request ID. In various embodiments, whenever a table is loaded, there is a key-value pair for any link, causing the link to be associated with a unique ID. This unique ID is used to navigate to the page and populate the data. As another example, the process validates data by mapping rules for each page to determine what rules are to be performed on any page. For example, a rule that applies to all contracts currently being reviewed is that the delivery date must be within Q2 of the current fiscal year. The process would find the date field and verify that the delivery date is before the end of the current fiscal year, e.g., June 30.

The process uses an ML model (e.g., based on a neural network regression algorithm) to check the historical data to determine whether a request can be auto-approved. An appropriate ML model is selected, and individual ML models may be trained for specific applications, e.g., approval process vs. a submission process. Different ML APIs are used depending on the page. For example, if the page is determined to expect an action for an approval process, the appropriate API is used to obtain an approval decision from the ML model. If the page expects a submission, the appropriate API is used to obtain submission content from the ML model.

FIG. 4 is a functional diagram illustrating a programmed computer system for providing a dynamic Web component with configurable content in accordance with some embodiments. As will be apparent, other computer system architectures and configurations can be used to provide a dynamic Web component with configurable content. Computer system 400, which includes various subsystems as described below, includes at least one microprocessor subsystem (also referred to as a processor or a central processing unit (CPU)) 402. For example, processor 402 can be implemented by a single-chip processor or by multiple processors. In some embodiments, processor 402 is a general purpose digital processor that controls the operation of the computer system 400. Using instructions retrieved from memory 410, the processor 402 controls the reception and manipulation of input data, and the output and display of data on output devices (e.g., display 418). In some embodiments, processor 402 includes and/or is used to perform the processes described herein with respect to FIG. 1.

Processor 402 is coupled bi-directionally with memory 410, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 402. Also as is well known in the art, primary storage typically includes basic operating instructions, program code, data and objects used by the processor 402 to perform its functions (e.g., programmed instructions). For example, memory 410 can include any suitable computer-readable storage media, described below, depending on whether, for example, data access needs to be bi-directional or uni-directional. For example, processor 402 can also directly and very rapidly retrieve and store frequently needed data in a cache memory (not shown).

A removable mass storage device 412 provides additional data storage capacity for the computer system 400, and is coupled either bi-directionally (read/write) or uni-directionally (read only) to processor 402. For example, storage 412 can also include computer-readable media such as magnetic tape, flash memory, PC-CARDS, portable mass storage devices, holographic storage devices, and other storage devices. A fixed mass storage 420 can also, for example, provide additional data storage capacity. The most common example of mass storage 420 is a hard disk drive. Mass storage 412, 420 generally store additional programming instructions, data, and the like that typically are not in active use by the processor 402. It will be appreciated that the information retained within mass storage 412 and 420 can be incorporated, if needed, in standard fashion as part of memory 410 (e.g., RAM) as virtual memory.

In addition to providing processor 402 access to storage subsystems, bus 414 can also be used to provide access to other subsystems and devices. As shown, these can include a display monitor 418, a network interface 416, a keyboard 404, and a pointing device 406, as well as an auxiliary input/output device interface, a sound card, speakers, and other subsystems as needed. For example, the pointing device 406 can be a mouse, stylus, track ball, or tablet, and is useful for interacting with a graphical user interface.

The network interface 416 allows processor 402 to be coupled to another computer, computer network, or telecommunications network using a network connection as shown. For example, through the network interface 416, the processor 402 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 402 can be used to connect the computer system 400 to an external network and transfer data according to standard protocols. For example, various process embodiments disclosed herein can be executed on processor 402, or can be performed across a network such as the Internet, intranet networks, or local area networks, in conjunction with a remote processor that shares a portion of the processing. Additional mass storage devices (not shown) can also be connected to processor 402 through network interface 416.

An auxiliary I/O device interface (not shown) can be used in conjunction with computer system 400. The auxiliary I/O device interface can include general and customized interfaces that allow the processor 402 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 4 is but an example of a computer system suitable for use with the various embodiments disclosed herein. Other computer systems suitable for such use can include additional or fewer subsystems. In addition, bus 414 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving an instruction to move a component from a first portion of a user interface to a second portion of the user interface for application on the second portion of the user interface, wherein the second portion is configured to receive an input from a user;
programmatically analyzing content of the second portion to select a machine learning model; and
determining, for the user, the input to the second portion using the selected machine learning model.

2. The method of claim 1, wherein the instruction to move a component from a first portion of a user interface to a second portion of the user interface includes dragging the component from the first portion and dropping the component to the second portion to cause the component to be applied to the second portion of the user interface.

3. The method of claim 1, wherein programmatically analyzing content of the second portion to select a machine learning model includes determining at least one host capability of an application associated with the user interface.

4. The method of claim 3, wherein the at least one host capability of the application associated with the user interface is determined based on at least one of: a host name or a contextual uniform resource locator (URL).

5. The method of claim 4, wherein determining the at least one host capability of the application associated with the user interface includes:
parsing the uniform resource locator (URL) to extract at least one keyword; and
determining a function of a page associated with the application based at least on a lookup of the at least one keyword in a lookup table.

6. The method of claim 1, wherein programmatically analyzing content of the second portion to select a machine learning model includes determining at least one of a configuration or a property of an application associated with the user interface.

7. The method of claim 6, wherein the configuration or the property of the application associated with the user interface includes at least one of: metadata of a page associated with the application, a widget, or a Document Object Model (DOM) element.

8. The method of claim 6, wherein a page type associated with the application is determined based at least on the configuration or the property of the application associated with the user interface.

9. The method of claim 1, wherein programmatically analyzing content of the second portion to select a machine learning model includes determining a page of an application associated with the second portion and selecting the machine learning model based at least on the determined page.

10. The method of claim 9, wherein information associated with the determined page is used to train the machine learning model.

11. The method of claim 1, wherein determining the input to the second portion using the selected machine learning model includes determining an action to perform with respect to the second portion on behalf of the user.

12. The method of claim 1, wherein determining the input to the second portion using the selected machine learning model includes using the selected machine learning model to determine permitted actions to take with respect to the second portion.

13. The method of claim 12, further comprising taking at least one action from among the determined permitted actions to take with respect to the second portion.

14. The method of claim 13, wherein taking the at least one action includes populating data in the second portion using a key-value pair for at least one link in the second portion.

15. The method of claim 13, wherein taking the at least one action includes validating data including by:
determining at least one applicable rule for the second portion; and
validating data in the second portion based on at least one rule.

16. A system, comprising:
a processor configured to:
receive an instruction to move a component from a first portion of a user interface to a second portion of the user interface for application on the second portion of the user interface, wherein the second portion is configured to receive an input from a user;
programmatically analyze content of the second portion to select a machine in learning model; and
determine for the user, the input to the second portion using the selected machine learning model; and
a memory coupled to the processor and configured to provide the processor with instructions.

17. The system of claim 16, wherein the instruction to move a component from a first portion of a user interface to a second portion of the user interface includes dragging the component from the first portion and dropping the component to the second portion to cause the component to be applied to the second portion of the user interface.

18. The system of claim 16, wherein programmatically analyzing content of the second portion to select a machine learning model includes determining at least one host capability of an application associated with the user interface.

19. The system of claim 16, wherein the at least one host capability of the application associated with the user interface is determined based on at least one of: a host name or a contextual uniform resource locator (URL).

20. A computer program product embodied in a non-transitory computer readable medium and comprising computer instructions for:
receiving an instruction to move a component from a first portion of a user interface to a second portion of the user interface for application on the second portion of the user interface, wherein the second portion is configured to receive an input from a user;
programmatically analyzing content of the second portion to select a machine learning model; and
determining, for the user, the input to the second portion using the selected machine learning model.
